(19) United States
(12) Patent Application Publication
(10) Pub. No.: US 2007/0057973 A1
(43) Pub. Date: Mar. 15, 2007

(54) Information processing apparatus and display control method

(75) Inventor: Rinzo Iwamoto, Nishitama-gun (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/513,222

(22) Filed: Aug. 31, 2006

(30) Foreign Application Priority Data
Aug. 31, 2005 (JP) P2005-252083

(51) Int. Cl. G09G 5/00

(52) U.S. Cl. 345/660

(57) ABSTRACT

According to one embodiment of the invention, an information processing apparatus comprising: a display unit capable of displaying at least one of a first video and a second video in which the first video is enlarged; an operation unit operating a pointer displayed on the display unit; and a control unit moving the pointer displayed on the first video by a first movement amount in accordance with an operation amount of the operation unit, when the first video is displayed on the display unit, or moving the pointer displayed on the second video by a second movement amount smaller than the first movement amount in accordance with the operation amount, when the second video is displayed on the display unit.

### CROSS-REFERENCE TO RELATED APPLICATIONS

This application is based upon and claims the benefit of priority from Japanese Patent Application No. 2005-252083, filed on Aug. 31, 2005, the entire contents of which are incorporated herein by reference.

### BACKGROUND

1. Field

One embodiment of the invention relates to relates to an information processing apparatus that can display a first video and a second video in which the first video is enlarged on a display unit, and a display control method.

2. Description of the Related Art

It is disclosed by JP-A-2000-293287, for example, as the Liquid Crystal Display (LCD) has higher definition, the contents displayed on the LCD may not be discriminated well in some cases. A function of temporarily enlarging the video to discriminate the contents displayed on the LCD has been proposed.

### SUMMARY

The related-art information processing apparatus is often operated by a pointer displayed on the LCD. The pointer operation is made employing a mouse or a touch pad. However, the sense of operating the pointer is different between the normal display time and the enlarged display time, resulting in a problem that the pointer is difficult to operate.

It is an object of the invention to provide an information processing apparatus and a display control method. According to one embodiment of the invention, the information processing apparatus can operate the pointer with no feeling of physical disorder even at the time of enlarged display.

According to an aspect of the invention, there is provided an information processing apparatus comprising: a display unit capable of displaying at least one of a first video and a second video in which the first video is enlarged; an operation unit operating a pointer displayed on the display unit; and a control unit moving the pointer displayed on the first video by a first movement amount in accordance with an operation amount of the operation unit, when the first video is displayed on the display unit, or moving the pointer displayed on the second video by a second movement amount smaller than the first movement amount in accordance with the operation amount, when the second video is displayed on the display unit.

According to the above-aspect, it is possible to operate the pointer with no feeling of physical disorder even at the time of enlarged display.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an example of the configuration of a notebook type personal computer as an information processing apparatus according to an embodiment of the present invention.

FIG. 2 is an exemplary block diagram showing an example of a system configuration of the computer.

FIG. 3 is an exemplary block diagram for implementing a zoom function of zooming the display on the LCD, and a function of changing the movement amount of pointer displayed on the LCD when the zoom function is effective.

FIG. 4 is an exemplary view showing a setting window by the utility.

FIG. 5 is an exemplary flowchart showing a procedure when the user operates a display mode switching button.

FIGS. 6A and 6B are exemplary views showing a video in the normal mode and a video in the zoom mode that are displayed on the LCD.

FIGS. 7A, 7B, and 7C are exemplary views showing the relationship between the operation amount of touch pad and the movement amount of pointer on the LCD.

### DETAILED DESCRIPTION

Various embodiments according to the invention will be described hereinafter with reference to the accompanying drawings. In general, according to one embodiment of the invention, an information processing apparatus comprising: a display unit capable of displaying at least one of a first video and a second video in which the first video is enlarged; an operation unit operating a pointer displayed on the display unit; and a control unit moving the pointer displayed on the first video by a first movement amount in accordance with an operation amount of the operation unit, when the first video is displayed on the display unit, or moving the pointer displayed on the second video by a second movement amount smaller than the first movement amount in accordance with the operation amount, when the second video is displayed on the display unit.

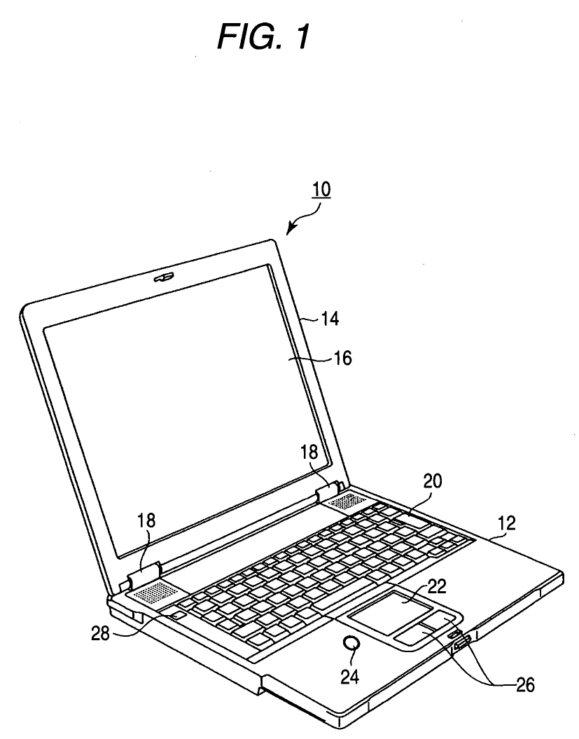

FIG. 1 is an exemplary view showing an exemplary configuration of a notebook type personal computer as an information processing apparatus according to one embodiment of the invention.

The personal computer 10 comprises a computer main body 12 and a display unit 14. The display unit 14 incorporates an LCD (Liquid Crystal Display) 16 into a display unit.

The display unit 14 is mounted around the hinges (supports) 18 provided at the end portions in the rear of the computer main body 12 to be freely turnable between an open position where an upper face of the computer main body 12 is covered and a closed position where the upper face of the computer main body 12 is exposed.

The computer main body 12 comprises a thin box housing, and is provided with a keyboard 20 in the central part on the upper face of the housing. A palm rest is formed on the upper face of a housing portion in the fore of the computer main body 12. A touch pad 22 as an operation unit, a touch pad control button 26 and a display mode switching button 24 as input means are provided in the almost central part of the palm rest. A power button 28 for turning on/off the power of the computer man body 12 is provided on the upper face of the housing portion in the rear of the computer main body 12.

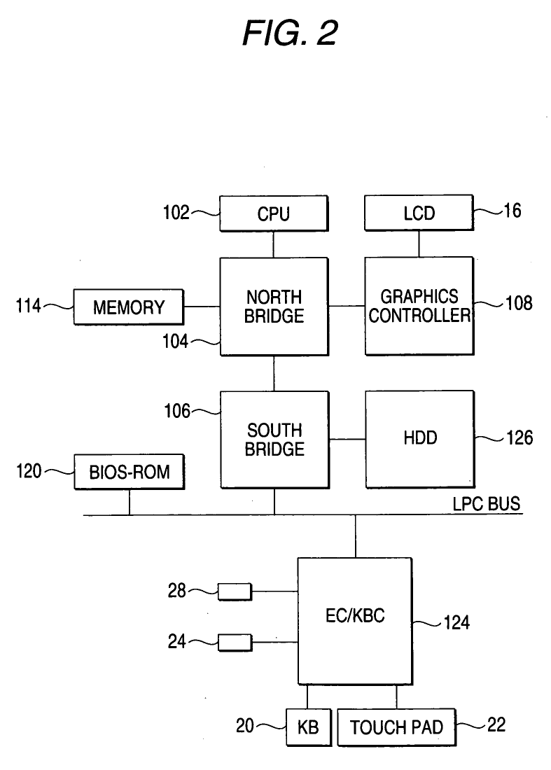

Referring to FIG. 2, one example of a system configuration of the computer will be described below.

The computer comprises a CPU 102, a north bridge 104, a main memory 114, a graphics controller 108, a south bridge 106, a BIOS-ROM 120, a hard disk drive (HDD) 126, an embedded controller/keyboard controller IC (EC/KBC) 124 and a power supply 125, as exemplary shown in FIG. 2.

The CPU 102 is a processor provided to control the operation of this computer, and executes an operating system (OS) and various kinds of application that are loaded from the hard disk drive (HDD) 126 to the main memory 114.

The CPU 102 loads a system BIOS (Basic Input Output System) stored in the BIOS-ROM 120 into the main memory 114, and executes it. The system BIOS is a program for hardware control.

The north bridge 104 is a bridge device for connection between a local path of the CPU 102 and the south bridge 106. The north bridge 104 contains a memory controller for making the access control of the main memory 114. Also, the north bridge 104 has a function of making the communications with the graphics controller 108 via an AGP (Accelerated Graphics Port).

The graphics controller 108 is a display controller for controlling the LCD 16 used as a display monitor of the computer. The graphics controller 108 comprises a video memory (VRAM), and generates a video signal for forming a display image to be displayed on the LCD 16 from the display data drawn in the video memory by the OS/application program. The video signal generated by the graphics controller 108 is outputted to the line.

The embedded controller/keyboard controller IC (filter control part) 124 controls the touch pad 22 as input means, the display mode switching button 24, and the touch pad control button 26. The embedded controller/keyboard controller IC 124 is a one-chip microcomputer for monitoring and controlling various kinds of devices (peripheral devices, sensors, a power supply circuit, etc.), irrespective of the system condition of the computer 10.

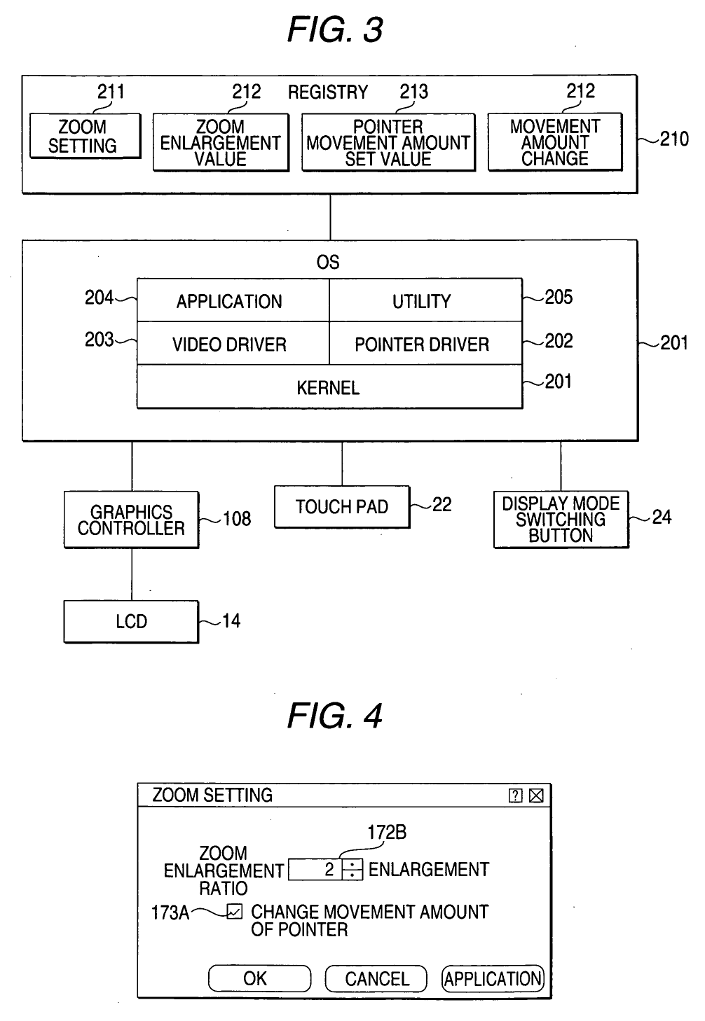

FIG. 3 is an exemplary block diagram for implementing a zoom function of enlarging and displaying a part of an image on a screen of the LCD 16, and a function of changing the movement amount of pointer displayed on the LCD 16 when the zoom function is effective.

The computer 10 has a kernel 201, a mouse driver 202 as a control unit, a video driver 203, an application 204, and a utility 205 as a setting unit within the operating system 200.

The utility 205 displays a setting window on the LCD 16, as exemplary shown in FIG. 4, and switch a zoom setting 211 between valid and invalid according to an operation of the display mode switching button 24 by the user. When the zoom setting 211 is valid, the video driver 203 controls the graphics controller 108 to enlarge a part of an image on the screen at an enlargement ratio according to a zoom enlargement value 212 stored in the registry 210 and display it on the LCD 16. The mouse driver 202 controls to move the pointer displayed on the LCD 16 by a movement amount according to a pointer movement amount set value 213 stored in the registry 210, when the user operates the touch pad 22. The pointer movement amount setting value 213 is the movement amount of the pointer per unit operation amount of the touch pad 22.

The utility 205 displays a window on the LCD 16, as exemplary shown in FIG. 4. If the user changes the number in an enlargement setting column 221, the zoom enlargement value 212 is changed. The utility 205 changes the pointer movement amount set value 213 according to the zoom enlargement value 212 and changes the movement amount of the pointer, if a check button 222 is checked and the zoom function is effective.

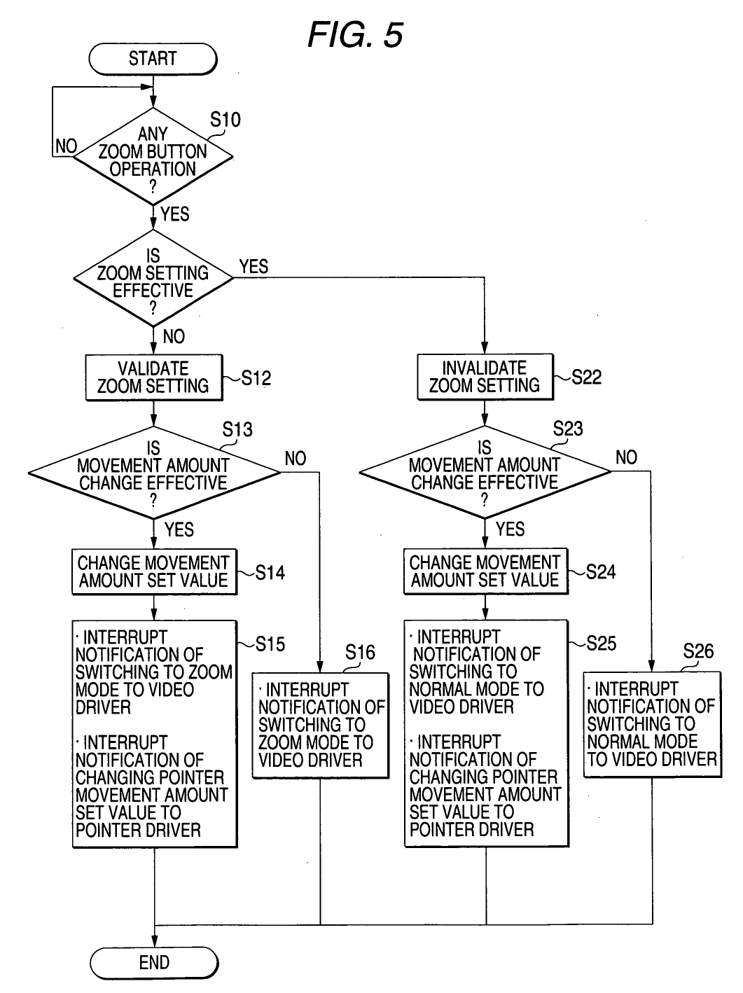

Referring to a flowchart of FIG. 5, a procedure when the user operates the display mode switching button 24 will be described below.

The utility 205 determines whether or not the display mode switching button 24 is operated at regular interval (step S10). If the display mode switching button is operated, the utility 205 determines whether or not the value of the zoom setting 211 is effective by referring to the zoom setting 211 (step S11).

If the zoom set value is ineffective (No at step S11), the utility 205 makes the value of the zoom setting 211 effective (step S12).

The utility 205 determines whether or not the movement amount of the pointer is set to be changed according to the switching of the mode by referring to the value of a movement amount change 214 (step S13). If the value of the movement amount change 214 is not set to change the movement amount of the pointer (No at step S13), the utility 205 makes an interrupt notification of switching to the zoom mode (second mode) to the video driver 203, and switches the normal mode (first mode) to the zoom mode (second mode) (step S16).

If the value of the movement amount change 214 is set to change the movement amount of the pointer (Yes at step S13), the utility 205 changes the currently set pointer movement amount so that the movement amount of the pointer in operating the touch pad 22 by the same operation amount may be smaller than in the normal mode (step S14). For example, the result of dividing the current point movement amount set value 213 by the zoom enlargement value 212 may be made the new pointer movement amount set value 213. An area for storing the pointer movement amount set value in the normal mode when switching the zoom mode to the normal mode may be provided in the register, and the pointer movement amount set value in the normal mode may be read from this area, and rewritten into the pointer movement amount set value 213.

The utility 205 makes an interrupt notification of switching to the zoom mode to the video driver 203 and switches to the zoom mode, and makes an interrupt notification that the pointer movement amount set value 213 has been changed to the mouse driver 202, whereby the mouse driver 202 controls the movement of the pointer at a new value of the pointer movement amount set value 213 (step S15).

If the value of the zoom setting 211 is valid at step S11 (Yes at step S11), the utility 205 invalidates the value of the zoom setting 211 (step S22).

The utility 205 determines whether or not the movement amount of the pointer is set to be changed according to the switching of the mode by referring to the value of the movement amount change 214 (step S23). If the value of the movement amount change 214 is not set to change the movement amount of the pointer (No at step S23), the utility 205 makes an interrupt notification of switching to the normal mode to the video driver 203, and switches the zoom mode to the normal mode (step S26).

If the value of the movement amount change 214 is set to change the movement amount of the pointer (Yes at step S23), the utility 205 changes the current pointer movement amount setting so that the movement amount of the pointer in operating the touch pad 22 by the same operation amount may be larger than in the zoom mode (step S24). For example, the result of multiplying the current point movement amount set value 213 by the zoom enlargement value 212 may be made the new pointer movement amount set value 213. An area for storing the pointer movement amount set value in the normal mode in switching the normal mode to the zoom mode may be provided in the register, and the pointer movement amount set value in the normal mode may be read from this area, and rewritten into the pointer movement amount set value 213.

The utility 205 makes an interrupt notification of switching to the normal mode to the video driver 203 and switches to the normal mode, and makes an interrupt notification that that the pointer movement amount set value 213 has been changed to the mouse driver 202, whereby the mouse driver 202 controls the movement of the pointer at a new value of the pointer movement amount set value 213 (step S25).

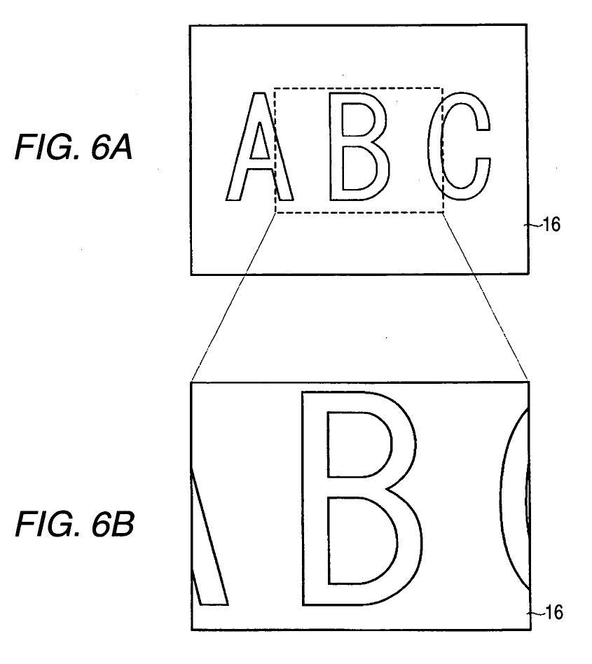

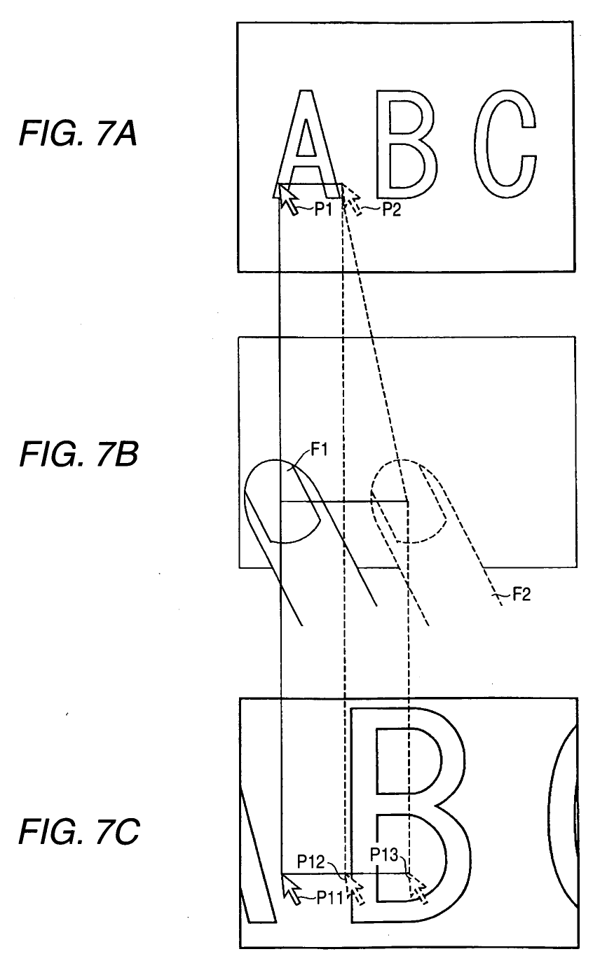

The video (first video) in the normal mode (first mode) as exemplary shown in FIG. 6A and the video (second video) in the zoom mode in which the video in the normal mode is enlarged double as exemplary shown in FIG. 6B are displayed on the LCD 16 (second mode). When the pointer is moved from position P1 to position P2 in the normal mode as exemplary shown in FIG. 7A, the finger is moved from position F1 to position F2 as exemplary shown in FIG. 7B. By the way, in the zoom mode as exemplary shown in FIG. 7C, when the pointer is moved from position P11 to position P12 which has equal distance between position P1 and position P2 on the display, the user moves the finger from position F1 to position F2 in a sense of the normal mode. However, when the movement amount setting of the pointer is not changed between the normal mode and the zoom mode, the pointer is moved to position P13, because the video displayed on the LCD 16 is enlarged double. However, when the movement amount setting is changed between the normal mode and the zoom mode, the set movement amount of the pointer is halved from the movement amount in the normal mode, whereby if the finger is moved from position F1 to position F2, the pointer is moved from position P11 to position P12. Accordingly, the user has no different feeling of operating the pointer between the normal mode and the zoom mode, and can operate the pointer with no feeling of physical disorder.

Though the normal mode or the zoom mode is exclusively effected in the above embodiment, it will be appreciated that the normal mode and the zoom mode may be displayed at the same time by dividing the display area of the LCD 16 whereby the movement amount of the pointer per unit operation amount of the touch pad 22 may be changed in accordance with the mode of the area where the pointer exists on the screen.

The present invention is not limited to that precise embodiment, and various modifications may be made without departing from the spirit or scope of the invention. Also, the invention may be formed by an appropriate combination of components as disclosed in the above embodiment. For example, some of the components as described in the embodiment may be deleted. Moreover, the invention may encompass appropriate combinations of components in different embodiments. While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display unit capable of displaying at least one of a first video and a second video in which the first video is enlarged;
an operation unit operating a pointer displayed on the display unit; and
a control unit moving the pointer displayed on the first video by a first movement amount in accordance with an operation amount of the operation unit, when the first video is displayed on the display unit, or moving the pointer displayed on the second video by a second movement amount smaller than the first movement amount in accordance with the operation amount, when the second video is displayed on the display unit.

2. The information processing apparatus according to claim 1, further comprising:
a setting unit setting the second movement amount based on an enlargement ratio used to generate the second video.

3. The information processing apparatus according to claim 1, further comprising:
a setting unit setting whether or not to move the pointer by the second movement amount smaller than the first movement amount, when the second video is displayed on the display unit.

4. An information processing apparatus comprising:
a display unit displaying a first video in a first mode, and displaying a second video in which the first video is enlarged in a second mode;
an operation unit moving a pointer capable of being displayed on the first video or the second video; and
a setting unit setting the movement amount of the pointer per unit operation amount of the operation unit in accordance with each mode.

5. The information processing apparatus according to claim 4, wherein the setting unit sets a smaller movement amount in the second mode than the movement amount of the pointer per the unit operation amount in the first mode, and
wherein the setting unit sets a larger movement amount in the first mode than the movement amount of the pointer per the unit operation amount in the second mode.

6. The information processing apparatus according to claim 4, wherein the setting unit sets the movement amount of the pointer per the unit operation amount in accordance with an enlargement ratio of the second mode.

7. The information processing apparatus according to claim 4, further comprising:
a switching unit switching between the first mode and the second mode, wherein the setting unit sets the movement amount of the point per unit operation amount for the operation unit in accordance with the mode switched by the switching unit.

8. An information processing method of an information processing apparatus comprising:
a display unit capable of displaying at least one of a first video and a second video in which the first video is enlarged; and
an operation unit operating a pointer displayed on the display unit, comprising:
moving the pointer displayed on the first video by a first movement amount in accordance with an operation amount of the operation unit, when the first video is displayed on the display unit; and
moving the pointer displayed on the second video by a second movement amount smaller than the first movement amount in accordance with the operation amount.

9. The information processing method according to claim 8, comprising:
setting the second movement amount based on an enlargement ratio used to generate the second video.

10. The information processing method according to claim 8, wherein the information processing apparatus comprises:
a setting unit setting whether or not to move the pointer by the second movement amount, when the second video is displayed on the display unit, and
wherein when setting to move the pointer by the second movement amount is performed by the setting unit, the pointer is moved in the second movement amount.
